(19) United States
(12) Patent Application Publication
(10) Pub. No.: US 2026/0050803 A1
(43) Pub. Date: Feb. 19, 2026

(54) ONTOLOGY UPDATE APPARATUS, VEHICLE, AND ONTOLOGY UPDATE METHOD

(71) Applicant: SUBARU CORPORATION, Tokyo (JP)

(72) Inventor: Hiroki MARUMO, Tokyo (JP)

(73) Assignee: SUBARU CORPORATION, Tokyo (JP)

(21) Appl. No.: 19/115,968

(22) PCT Filed: Sep. 8, 2023
(86) PCT No.: PCT/JP2023/032856

§ 371 Date: Mar. 27, 2025

(51) Int. Cl. G06N 5/025; B60W 50/00; G06V 20/56

(52) U.S. Cl. CPC G06N 5/025; B60W 50/0098; G06V 20/56

(57) ABSTRACT

An ontology update apparatus according to an embodiment of the disclosure includes a controller configured to update an ontology. The controller is configured to perform the following two:
(1) determining a similarity level between a surrounding situation of a vehicle and a risk situation described in the ontology, and determining that the surrounding situation is not described in the ontology when the controller determines that the similarity level is low; and
(2) determining whether a risk event is present around the vehicle, based on data that is obtained from a device mounted on the vehicle at a time when the surrounding situation is acquired, and, when the controller determines that a risk event is present around the vehicle, updating the ontology by adding the surrounding situation and the risk event in association with each other to the ontology.

### TECHNICAL FIELD

The disclosure relates to an ontology update apparatus, a vehicle, and an ontology update method.

### BACKGROUND ART

Techniques are known that assist a vehicle in traveling in consideration of risks present around the vehicle. For example, Patent Literature 1 discloses a technique of warning a driver who does not comply with traffic rules described in an ontology. Further, for example, Patent Literature 2 discloses a technique of predicting rushing out in front of a vehicle, based on traffic rules and inference rules described in an ontology.

### CITATION LIST

### Patent Literature

Patent Literature 1: Japanese U.S. Pat. No. 5,932,984

Patent Literature 2: Japanese U.S. Pat. No. 6,978,313

### SUMMARY OF INVENTION

A first aspect of the disclosure provides an ontology update apparatus including a controller configured to update an ontology. The controller is configured to perform the following two:
(A1) determining a similarity level between a surrounding situation of a vehicle and a risk situation described in the ontology, and determining that the surrounding situation is not described in the ontology when the controller determines that the similarity level is low; and
(A2) determining whether a risk event is present around the vehicle, based on data that is obtained from a device mounted on the vehicle at a time when the surrounding situation is acquired, and, when the controller determines that a risk event is present around the vehicle, updating the ontology by adding the surrounding situation and the risk event in association with each other to the ontology.

A second aspect of the disclosure provides a vehicle including a storage and a controller. The storage contains an ontology. The controller is configured to update the ontology. The controller is configured to perform the following two:
(B1) determining a similarity level between a surrounding situation of the vehicle and a risk situation described in the ontology, and determining that the surrounding situation is not described in the ontology when the controller determines that the similarity level is low; and
(B2) determining whether a risk event is present around the vehicle, based on data that is obtained from a device mounted on the vehicle at a time when the surrounding situation is acquired, and, when the controller determines that a risk event is present around the vehicle, updating the ontology by adding the surrounding situation and the risk event in association with each other to the ontology.

A third aspect of the disclosure provides an ontology update method including the following (C1) and (C2):
(C1) determining a similarity level between a surrounding situation of a vehicle and a risk situation described in an ontology, and determining that the surrounding situation is not described in the ontology when the controller determines that the similarity level is low; and
(C2) determining whether a risk event is present around the vehicle, based on data that is obtained from a device mounted on the vehicle at a time when the surrounding situation is acquired, and, when the controller determines that a risk event is present around the vehicle, updating the ontology by adding the surrounding situation and the risk event in association with each other to the ontology.

### BRIEF DESCRIPTION OF DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a schematic configuration example of a traveling control system according to one embodiment of the disclosure.

FIG. 2 is a diagram illustrating an example of inference rules described in an ontology DB of FIG. 1.

FIG. 3 is a diagram illustrating an example of traffic rules described in the ontology DB of FIG. 1.

FIG. 4 is a diagram illustrating an example of road concepts described in the ontology DB of FIG. 1.

FIG. 5 is a diagram illustrating an example of a traffic situation and a scenario of a risk situation A.

FIG. 6 is a diagram illustrating a state in which AEB is activated in the traffic situation of FIG. 5.

FIG. 7 is a diagram illustrating a state in which ABS is activated in the traffic situation of FIG. 5.

FIG. 8 is a diagram illustrating a state in which AES is activated in the traffic situation of FIG. 5.

FIG. 9 is a diagram illustrating a state in which VDC warning is activated in the traffic situation of FIG. 5.

FIG. 10 is a diagram illustrating a state in which an airbag is activated in the traffic situation of FIG. 5.

FIG. 11 is a diagram illustrating an example of a driving assistance procedure in the traffic situation of FIG. 5.

FIG. 12 is a diagram illustrating an example of an ontology update procedure.

FIG. 13 is a diagram illustrating one modification example of the ontology update procedure.

FIG. 14 is a diagram illustrating one modification example of the ontology update procedure.

### MODES FOR CARRYING OUT THE INVENTION

Embodiments of the disclosure are described in detail below with reference to the drawings.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 1. Background

In recent years, automated driving control techniques have been developed that automatedly drive a vehicle such as an automobile without involving a driver's driving operation. Further, various proposals have been made for a driving assistance apparatus that performs various controls to assist in the driver's driving operation by using this type of automated driving control technique, and the driving assistance apparatus has generally been put into practical use. Techniques related to such a driving assistance apparatus are disclosed in, for example, Patent Literatures 1 and 2.

Patent Literature 1 discloses a technique of warning a driver who does not comply with traffic rules described in an ontology. Patent Literature 2 discloses a technique of predicting rushing out in front of a vehicle, based on traffic rules and inference rules described in an ontology. However, the inventions described in Patent Literatures 1 and 2 have an issue in that inference is not established in a rule that is not described in the ontology.

Hence, the inventor of the present application has devised, as a result of research, a technique that makes it possible to establish inference even in an inference rule that is not described in an ontology. A traveling control system for achieving the technique is described in detail below.

### 2. Embodiment

### Configuration Example

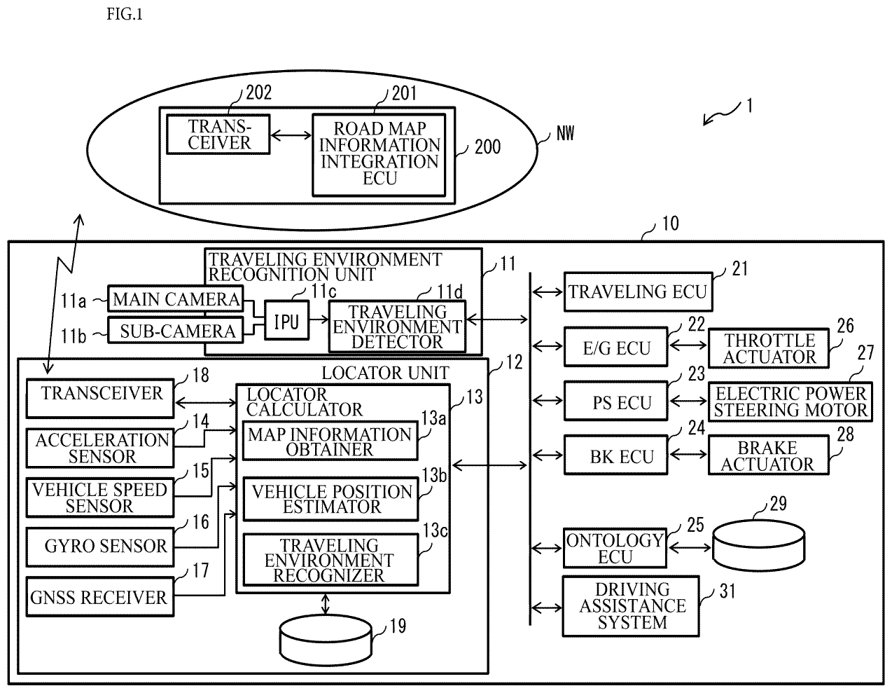

FIG. 1 illustrates a schematic configuration example of a traveling control system 1 according to an embodiment of the disclosure. For example, as illustrated in FIG. 1, the traveling control system 1 includes traveling control apparatuses 10 and a traffic control apparatus 200. The traveling control apparatuses 10 are mounted on respective vehicles. The traffic control apparatus 200 is provided in a network environment NW. The traveling control apparatuses 10 are coupled to the network environment NW through wireless communication. The traveling control apparatuses 10 each correspond to a specific example of an “ontology update apparatus” according to an embodiment of the disclosure.

The traffic control apparatus 200 sequentially integrates and updates pieces of road map information transmitted from the traveling control apparatuses 10 of the respective vehicles. The traffic control apparatus 200 transmits the updated road map information to each of the vehicles. The traffic control apparatus 200 includes, for example, a road map information integration ECU 201 and a transceiver 202.

The road map information integration ECU 201 integrates the pieces of road map information collected from the respective vehicles through the transceiver 202 to sequentially update the pieces of road map information on the surroundings of the vehicles on roads. For example, the pieces of road map information each include a dynamic map. The dynamic map includes static information, quasi-static information, quasi-dynamic information, and dynamic information. The static information and the quasi-static information are mainly included in road information. The quasi-dynamic information and the dynamic information are mainly included in traffic information.

The static information included in the road information includes, for example, information to be updated every month or more frequently. Examples of such information include information on roads and structures on roads, information on structures around roads, information on lanes, information on road surfaces, and information on permanent regulations. Examples of the “roads” include road positions and shapes, intersections, and road attributes (e.g., national roads, prefectural roads, municipal roads, private roads, priority roads, non-priority roads, ordinary roads, or highways). Examples of the “structures on roads” include traffic signs, traffic lights, traffic mirrors, and pedestrian bridges. Examples of the “structures around roads” include various buildings and parks.

The quasi-static information included in the road information includes, for example, information to be updated every hour or more frequently. Examples of such information include information on traffic regulations caused by road constructions or events, information on wide-area weather, and information on traffic congestion prediction.

The quasi-dynamic information included in the traffic information includes, for example, information to be updated every minute or more frequently. Examples of such information include information on temporary traffic obstruction caused by actual traffic congestion, traveling regulations, fallen objects, or obstacles at the time of observation, information on actual accidents, and information on narrow-area weather.

The dynamic information included in the traffic information includes, for example, information to be updated by the second. Examples of such information include information to be transmitted and exchanged between mobile bodies, information on the current indication of traffic lights, information on pedestrians and bicycles at intersections, and information on vehicles traveling on roads. Such road map information is maintained or updated in a cycle until the next information is received from each vehicle. The updated road map information is transmitted as appropriate to each vehicle through the transceiver 202.

The traveling control apparatus 10 includes a traveling environment recognition unit 11 and a locator unit 12 as units that recognize a traveling environment around the vehicle. The traveling control apparatus 10 further includes a traveling control unit (hereinafter referred to as traveling ECU) 21, an engine control unit (hereinafter referred to as E/G ECU) 22, a power steering control unit (hereinafter referred to as PS ECU) 23, a brake control unit (hereinafter referred to as BK ECU) 24, and an ontology control unit (hereinafter referred to as ontology ECU) 25. These control units 21, 22, 23, 24, and 25 are coupled together with the traveling environment recognition unit 11 and the locator unit 12 through in-vehicle communication lines such as a controller area network (CAN).

The traveling ECU 21 controls the vehicle, for example, in accordance with a driving mode. The driving mode includes, for example, a manual driving mode and a traveling control mode. The manual driving mode is a driving mode in which a driver is to keep steering the vehicle. For example, in the manual driving mode, an own vehicle is caused to travel in accordance with the driver's driving operation including a steering operation, an accelerator operation, and a brake operation. The traveling control mode is a driving mode that supports the driver in a driving operation, for example, to increase the safety of a pedestrian or a vehicle around the vehicle serving as the own vehicle. In the traveling control mode, when, for example, the own vehicle approaches an intersection, the traveling ECU 21 is configured to predict an action of a traveling vehicle or a stopped vehicle (hereinafter referred to as target vehicle) on a road intersecting at the intersection. If the target vehicle is likely to enter the intersection as a result of the prediction, the traveling ECU 21 is configured to, for example, call attention to or warn the driver, and further perform risk avoidance control such as braking. Detailed processing contents in the traveling control mode are described in detail below.

The E/G ECU 22 has an output side coupled to a throttle actuator 26. The throttle actuator 26 opens and closes a throttle valve of an electronically controlled throttle provided in a throttle body of an engine. The E/G ECU 22 controls the operation of the throttle actuator 26 by outputting a drive signal to the throttle actuator 26. The throttle actuator 26 opens and closes the throttle valve based on the drive signal from the E/G ECU 22 to regulate an intake air flow rate, thereby generating a desired engine output.

The PS ECU 23 has an output side coupled to an electric power steering motor 27. The electric power steering motor 27 imparts steering torque to a steering mechanism by using rotatory force of a motor. The PS ECU 23 controls the operation of the electric power steering motor 27 by outputting a drive signal to the electric power steering motor 27. In automated driving, the electric power steering motor 27 performs lane keep traveling control and lane change control, based on the drive signal from the PS ECU 23. The lane keep traveling control keeps the own vehicle traveling in the current traveling lane. The lane change control moves the own vehicle to an adjacent lane, for example, for overtaking control.

The BK ECU 24 has an output side coupled to a brake actuator 28. The brake actuator 28 regulates brake hydraulic pressure to be supplied to a brake wheel cylinder provided in each wheel. The BK ECU 24 controls the operation of the brake actuator 28 by outputting a drive signal to the brake actuator 28. The brake actuator 28 causes the brake wheel cylinder to generate brake force for each wheel to allow for forcible deceleration, based on the drive signal from the BK ECU 24.

The ontology ECU 25 is coupled to an ontology database 29. The ontology database 29 is a database described in web ontrogy language (OWL), and is stored in a mass storage medium such as an HDD. The ontology ECU 25 reads the data in the ontology database 29 and updates the data in the ontology database 29 under the control of the traveling ECU 21.

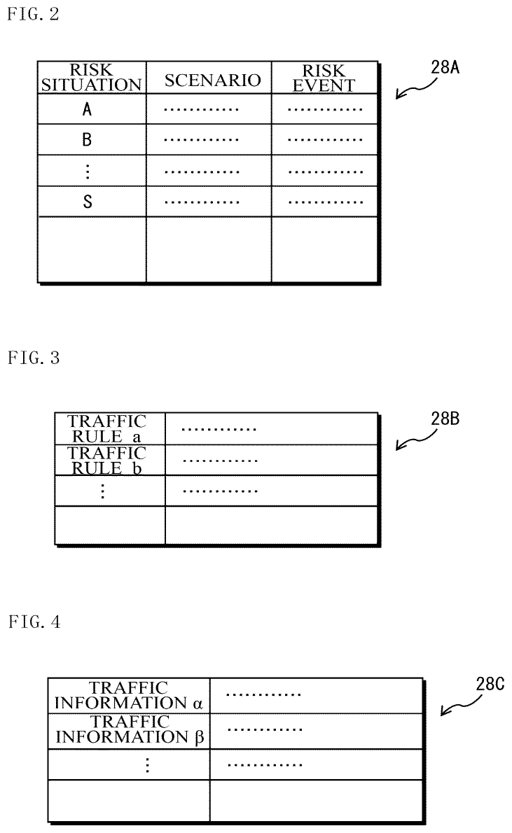

The ontology database 29 has an ontology data structure in which, for example, inference rules 28A, traffic rules 28B, and traffic information 28C are implemented by respectively embodying concepts illustrated in FIGS. 2, 3, and 4. In the inference rules 28A, risk situations (A, B, . . . , and S) that can be present around the vehicle are described as scenarios. In the scenario, identifiers are given to each vehicle present around the vehicle, and a position and a speed of each vehicle are associated with each vehicle. In the scenario, a traveling lane and a type of each vehicle are also associated with each vehicle, and traffic rules and traffic information are included. The traffic rules refer to rules that are to be followed by traffic participants in order to participate in traffic under the rules, for example, rules about the road information collected by the road map information integration ECU 201. The traffic information refers to, for example, the traffic information collected by the road map information integration ECU 201. In addition, in the inference rules 28A, each risk situation is associated with a risk event that can occur in the risk situation. Examples of the risk event include a traffic participant's rushing out from a blind spot. The inference rules 28A describe the risk situation (scenario) as a conditional term and the risk event as a resulting term. The traffic rules 28B describe the rules about the road information collected by the road map information integration ECU 201. The traffic information 28C describes the traffic information collected by the road map information integration ECU 201. The traffic rules 28B and the traffic information 28C serve as background knowledge to be used to infer the risk event based on the scenario.

The traveling environment recognition unit 11 is fixed, for example, at an upper middle position in a front interior part of the vehicle. The traveling environment recognition unit 11 includes an in-vehicle camera, an image processing unit (IPU) 11c, and a traveling environment detector 11d. The in-vehicle camera is a stereo camera including a main camera 11a and a sub-camera 11b.

The main camera 11a and the sub-camera 11b are autonomous sensors that each sense a real space around the vehicle. The main camera 11a and the sub-camera 11b are disposed, for example, at respective positions bilaterally symmetrical about the middle of the vehicle in a width direction. The main camera 11a and the sub-camera 11b are configured to stereoscopically image a region in front of the vehicle from different viewpoints.

The IPU 11c is configured to generate a distance image based on a pair of stereo images of the region in front of the vehicle captured by the main camera 11a and the sub-camera 11b. The distance image is obtained from an amount of deviation between corresponding positions of the target.

The traveling environment detector 11d is configured to detect a lane line that defines a road around the vehicle, for example, based on the distance image received from the IPU 11c. The traveling environment detector 11d is further configured to calculate, for example, road curvatures [1/m] of the respective lane lines that define the left and right sides of a traveling course (traveling lane) in which the vehicle is traveling and a width between the left and right lane lines. This width corresponds to the vehicle width. The traveling environment detector 11d is further configured to perform, for example, predetermined pattern matching on the distance image to detect a lane or a three-dimensional object such as a structure around the vehicle.

Here, when the traveling environment detector 11d detects a three-dimensional object, the traveling environment detector 11d detects, for example, a type of the three-dimensional object, a distance to the three-dimensional object, a speed of the three-dimensional object, and a relative speed between the three-dimensional object and the vehicle serving as the own vehicle. Examples of three-dimensional objects to be detected include traffic lights, intersections, road signs, stop lines, other vehicles, pedestrians, and various buildings. The traveling environment detector 11d is configured to output, for example, the detected pieces of information on the three-dimensional object to the traveling ECU 21.

The locator unit 12 estimates the position of the vehicle on a road map. The position of the vehicle is referred to as an own vehicle position below. The locator unit 12 includes a locator calculator 13 that estimates the own vehicle position. The locator calculator 13 has an input side coupled to sensors to be used to estimate the position of the vehicle (the own vehicle position). Examples of such sensors include an acceleration sensor 14, a vehicle speed sensor 15, a gyro sensor 16, and a GNSS receiver 17. The acceleration sensor 14 is configured to detect a longitudinal acceleration rate of the vehicle. The vehicle speed sensor 15 is configured to detect a speed of the vehicle. The gyro sensor 16 is configured to detect an angular velocity or an angular acceleration rate of the vehicle. The GNSS receiver 17 is configured to receive positioning signals emitted from positioning satellites. The locator calculator 13 is coupled to a transceiver 18. The transceiver 18 transmits and receives information to and from the traffic control apparatus 200. In addition, the transceiver 18 transmits and receives information to and from another vehicle.

The locator calculator 13 is also coupled to a high-precision road map database 19. The high-precision road map database 19 is a mass storage medium such as an HDD. The high-precision road map database 19 stores high-precision road map information. The high-precision road map information is also referred to as the dynamic map. This high-precision road map information includes, for example, static information, quasi-static information, quasi-dynamic information, and dynamic information as with the road map information included in the road map information integration ECU 201. The static information and the quasi-static information are mainly included in the road information. The quasi-dynamic information and the dynamic information are mainly included in the traffic information.

The locator calculator 13 includes, for example, a map information obtainer 13a, a vehicle position estimator 13b, and a traveling environment recognizer 13c.

The vehicle position estimator 13b is configured to acquire position coordinates of the vehicle serving as the own vehicle, based on positioning signals received by the GNSS receiver 17. The vehicle position estimator 13b is configured to match the acquired position coordinates to route map information to estimate the own vehicle position on the road map. The map information obtainer 13a is configured to acquire map information on a predetermined area from the map information stored in the high-precision road map database 19, based on the position coordinates of the own vehicle acquired by the vehicle position estimator 13b. The predetermined area includes the own vehicle.

In an environment in which the vehicle position estimator 13b fails to receive valid positioning signals from the positioning satellites because of a decrease in sensitivity of the GNSS receiver 17 in the vehicle traveling, for example, in a tunnel, the vehicle position estimator 13b is configured to switch on autonomous navigation to estimate the own vehicle position on the road map. In the autonomous navigation, the own vehicle position is estimated based on the vehicle speed detected by the vehicle speed sensor 15, the angular velocity detected by the gyro sensor 16, and the longitudinal acceleration rate detected by the acceleration sensor 14.

The vehicle position estimator 13b is configured to estimate the position of the vehicle (the own vehicle position) on the road map based on, for example, the positioning signals received by the GNSS receiver 17 or information detected by the gyro sensor 16 or another sensor as described above. The vehicle position estimator 13b is configured to determine, for example, a road type of the traveling course in which the own vehicle is traveling, based on the estimated own vehicle position on the road map.

The traveling environment recognizer 13c is configured to update the road map information stored in the high-precision road map database 19 with a latest version by using road map information acquired through external communication established through the transceiver 18. Examples of the external communication include road-to-vehicle communication and vehicle-to-vehicle communication. The quasi-static information, the quasi-dynamic information, and the dynamic information are also updated in addition to the static information. The road map information thus includes road information and traffic information acquired through the communication with the outside. Pieces of information on mobile bodies such as the vehicles traveling on roads are updated in real time.

The traveling environment recognizer 13c is configured to verify the road map information based on information on the traveling environment recognized by the traveling environment recognition unit 11. The traveling environment recognizer 13c is configured to update the road map information stored in the high-precision road map database 19 with the latest version. The quasi-static information, the quasi-dynamic information, and the dynamic information are also updated in addition to the static information. This updates, in real time, the pieces of information recognized by the traveling environment recognition unit 11 on mobile bodies such as the vehicles traveling on roads.

The pieces of respective road map information updated in this way are transmitted, for example, to the traffic control apparatus 200 and other vehicles around the vehicle serving as the own vehicle, through the road-to-vehicle communication and the vehicle-to-vehicle communication established through the transceiver 18. The traveling environment recognizer 13c is further configured to output the map information on the predetermined area in the updated road map information to the traveling ECU 21 along with the own vehicle position (vehicle position data). The predetermined area includes the own vehicle position estimated by the vehicle position estimator 13b.

The traveling control apparatus 10 further includes a driving assistance system 31. The driving assistance system 31 includes, for example, an autonomous emergency braking (AEB) system, an automatic emergency steering (AES) system, an anti-lock brake system (ABS), a vehicle dynamics control (VDC) system, and an airbag system.

The AEB system is a system that detects a preceding vehicle or an obstacle in front of the vehicle, and performs braking control on behalf of the driver upon determining that collision with the detected preceding vehicle or obstacle is inevitable. The AEB system outputs an AEB primary braking activation flag when AEB primary braking is performed, and outputs an AEB secondary braking activation flag when AEB secondary braking is performed. The AEB system outputs an AEB warning flag when the AEB system is activated.

The AES system is a system that detects a preceding vehicle or an obstacle in front of the vehicle, and performs steering control to avoid collision with the detected preceding vehicle or obstacle. The AES system outputs an AES activation flag when the steering control is performed.

The ABS is a system that performs braking control to prevent tires from locking when the driver applies sudden braking. The ABS outputs an ABS activation flag when the braking control is performed.

The VDC system is a system that controls traction of the vehicle. The VDC system outputs a VDC warning flag when the vehicle is about to reach the limit of traction.

The airbag system is a system that mitigates impact applied to the driver's head by colliding with, for example, a steering wheel, an instrument panel, or a windshield when the vehicle collides with a preceding vehicle or an obstacle in front of the vehicle. The airbag system outputs an airbag activation flag when the airbag is activated.

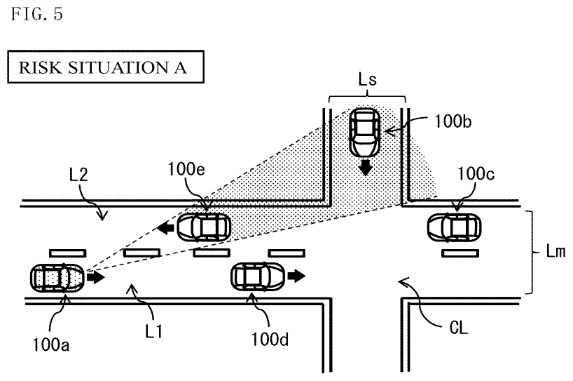

Next, the inference rules 28A will be described in detail. FIG. 5 illustrates an example of a traffic situation and a scenario of a risk situation A included in the inference rules 28A.

In the risk situation A, it is assumed that a first vehicle (own vehicle) 100a is traveling on a road with one lane on each side. The first vehicle 100a corresponds to a specific example of a “first vehicle” according to an embodiment of the disclosure. The road with one lane on each side includes a traveling lane L1 on which the first vehicle 100a is traveling and an oncoming lane L2 provided along the traveling lane L1 with a center line therebetween. The road with one lane on each side is provided with a no-traffic-light intersection CL in front of the first vehicle 100a. The road with one lane on each side is a priority road Lm in relation to a road intersecting the road with one lane on each side at the no-traffic-light intersection CL. In other words, the first vehicle 100a is traveling on the priority road Lm.

In contrast, the road intersecting the priority road Lm at the no-traffic-light intersection CL is a non-priority road Ls in relation to the priority road Lm. On the non-priority road Ls, a second vehicle (risk vehicle) 100b is traveling toward the no-traffic-light intersection CL. No traffic light is installed at the no-traffic-light intersection CL.

The driver of the first vehicle 100a recognizes that the first vehicle 100a is traveling on the priority road Lm. The first vehicle 100a is thus about to enter the no-traffic-light intersection CL without decelerating. At this time, the second vehicle 100b is traveling toward the no-traffic-light intersection CL on the non-priority road Ls. However, the second vehicle 100b is in a blind spot behind a fifth vehicle 100e traveling on the oncoming lane L2, as viewed from the driver of the first vehicle 100a, and the driver of the first vehicle 100a does not recognize the presence of the second vehicle 100b. A fourth vehicle 100d is traveling in front of the first vehicle 100a. The fourth vehicle 100d is traveling while decelerating toward the no-traffic-light intersection CL. On the oncoming lane L2, there is also a third vehicle 100c in addition to the fifth vehicle 100e. The third vehicle 100c is stopped before the no-traffic-light intersection CL. The driver of the second vehicle 100b recognizes the presence of the fourth vehicle 100d that is decelerating and the third vehicle 100c that is stopped. However, the driver of the second vehicle 100b does not recognize the presence of the first vehicle 100a because the first vehicle 100a is present in a blind spot behind the fifth vehicle 100e. The driver of the second vehicle 100b thus intends to pass through the no-traffic-light intersection CL immediately after the fourth vehicle 100d passes through the no-traffic-light intersection CL. In a such traffic situation, the first vehicle 100a and the second vehicle 100b are likely to cause a collision accident as they meet at the no-traffic-light intersection CL.

The scenario of such a risk situation A is stored in the inference rules 28A. In the inference rules 28A, the scenario of the risk situation A describes, for example, the following contents.

### Scenario of Risk Situation A

The priority road Lm and the non-priority road Ls intersect at the no-traffic-light intersection CL.
The first vehicle 100a is traveling on the priority road Lm and heading toward the no-traffic-light intersection CL.
The second vehicle 100b is traveling on the non-priority road Ls and heading toward the no-traffic-light intersection CL.
The second vehicle 100b is hidden in the blind spot as viewed from the first vehicle 100a.
The third vehicle 100c is stopped before the no-traffic-light intersection CL on the oncoming lane L2 opposite to the first vehicle 100a.
The fourth vehicle 100d is traveling in front of the first vehicle 100a and decelerating.

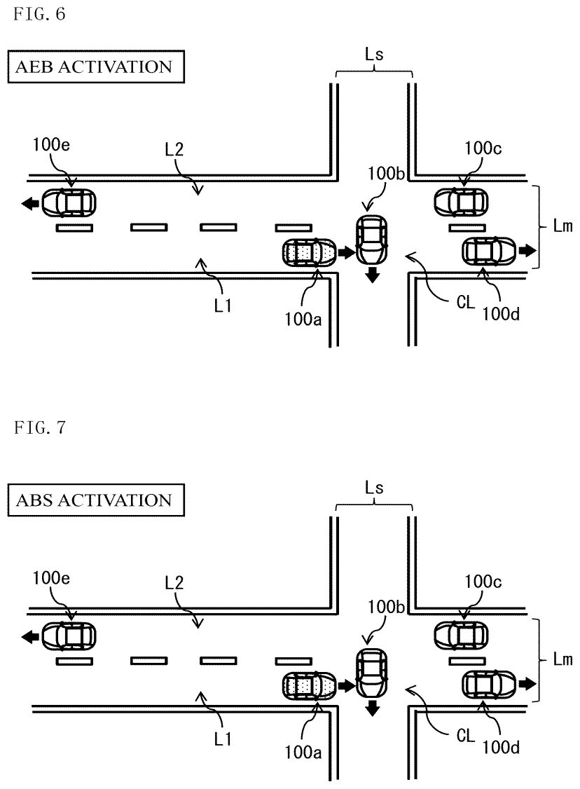

When the driver of the first vehicle 100a is performing an operation such as a braking operation in the risk situation A, for example, the AEB system of the first vehicle 100a is activated, as illustrated in FIG. 6, and the AEB activation flag (e.g., the AEB primary braking flag, the AEB secondary braking flag, or the AEB warning flag) is outputted from the AEB system. Alternatively, when the driver of the first vehicle 100a is performing an operation such as a braking operation in the risk situation A, for example, the ABS system of the first vehicle 100a is activated, as illustrated in FIG. 7, and the ABS activation flag is outputted from the ABS system.

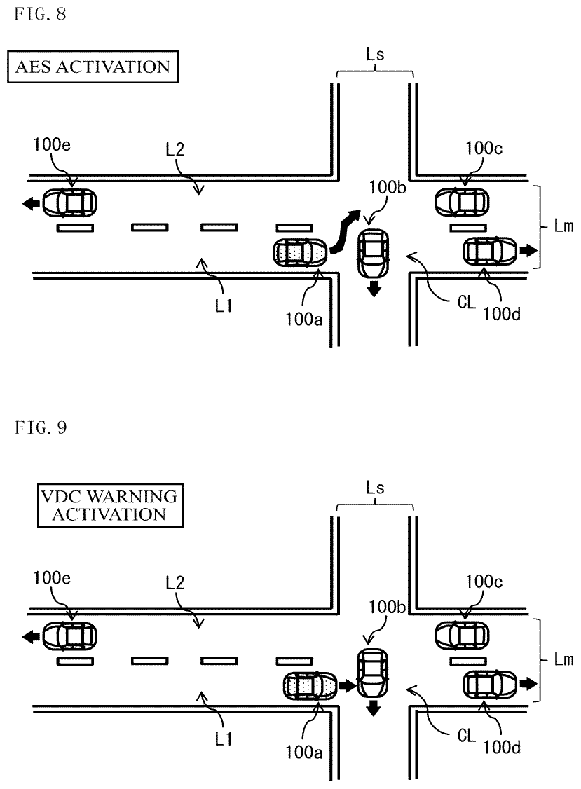

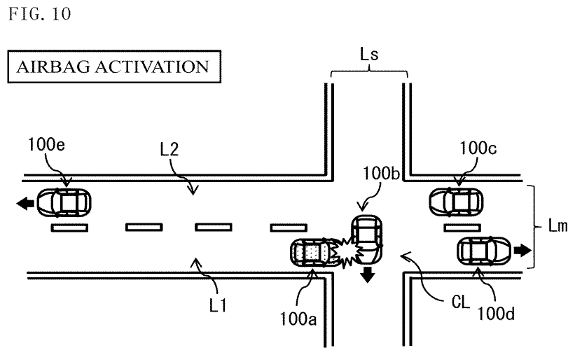

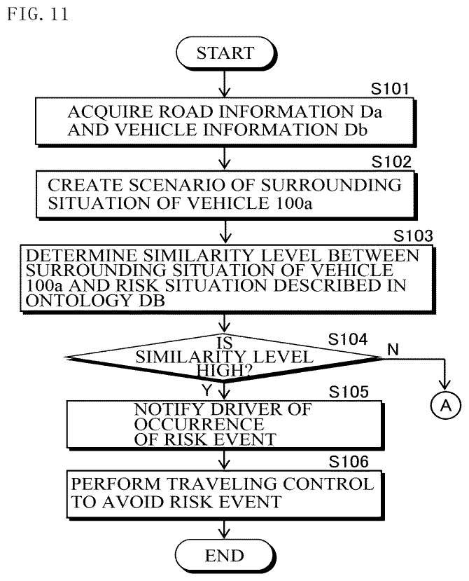

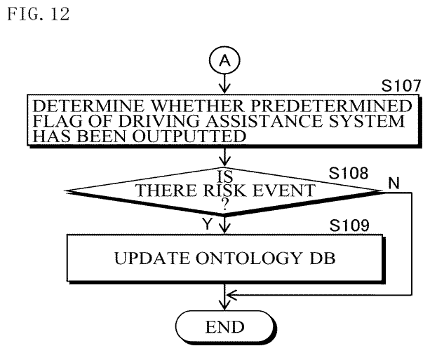

Alternatively, when the driver of the first vehicle 100a is performing an operation such as a driving operation in the risk situation A, for example, the AES system of the first vehicle 100a is activated, as illustrated in FIG. 8, and the AES activation flag is outputted from the AES system. Alternatively, when the driver of the first vehicle 100a is performing an operation such as a driving operation in the risk situation A, for example, the VDC system of the first vehicle 100a is activated, as illustrated in FIG. 9, and the VDC warning flag is outputted from the VDC system. Alternatively, in the risk situation A, for example, the first vehicle 100a collides with the second vehicle 100b, which activates the airbag system, as illustrated in FIG. 10, and the airbag activation flag is outputted from the airbag system.

Thus, in a situation in which the AEB activation flag, the ABG activation flag, the AES activation flag, the VDC warning flag, or the airbag activation flag is outputted, the first vehicle 100a and the second vehicle 100b are likely to cause a collision accident as they meet at the no-traffic-light intersection CL. In this specification, an event that is likely to occur in the risk situation A is referred to as a risk event. In the inference rules 28A, for example, the scenario of the risk situation A is associated with the risk event that is likely to occur in the risk situation A.

### Driving Assistance Procedure

Next, a driving assistance procedure in the traveling control system 1 will be described referring to FIG. 11. FIG. 11 illustrates an example of the driving assistance procedure in the traveling control system 1.

First, the stereo camera provided in the first vehicle 100a images the region in front of the first vehicle 100a, and outputs the stereo images thereby obtained to the IPU 11c. The IPU 11c generates the distance image based on the stereo images acquired by the stereo camera, and outputs the distance image to the traveling environment detector 11d. The traveling environment detector 11d performs, for example, predetermined pattern matching on the distance image generated by the IPU 11c to detect the priority road Lm, the traveling lane L1, the oncoming lane L2, the non-priority road Ls, the no-traffic-light intersection CL, the vehicle (e.g., 100a and 100c to 100e) on the priority road Lm, and the vehicle (e.g., 100b) on the non-priority road Ls.

Thereafter, the traveling environment recognizer 13c uses the road map information acquired by external communication to detect the priority road Lm, the traveling lane L1, the oncoming lane L2, the non-priority road Ls, the no-traffic-light intersection CL, the vehicle (e.g., 100a and 100c to 100e) on the priority road Lm, and the vehicle (e.g., 100b) on the non-priority road Ls. Here, it is assumed that the road map information acquired by external communication includes information on the vehicle (e.g., 100a and 100c to 100e) on the priority road Lm and information on the vehicle (e.g., 100b) on the non-priority road Ls. In this case, it is possible for the traveling environment recognizer 13c to detect the vehicle (e.g., 100a and 100c to 100e) on the priority road Lm and the vehicle (e.g., 100b) on the non-priority road Ls by using the road map information acquired by external communication.

The vehicle position estimator 13b acquires the position coordinates of the first vehicle 100a based on the positioning signals received by the GNSS receiver 17. The vehicle position estimator 13b further acquires the vehicle speed, i.e., the speed of the first vehicle 100a, detected by the vehicle speed sensor 15.

Thereafter, the traveling ECU 21 acquires road information Da and vehicle information Db, based on various pieces of information obtained from the traveling environment detector 11d, the vehicle position estimator 13b, and the traveling environment recognizer 13c (step S101). Here, the road information Da includes information on the priority road Lm, the traveling lane L1, the oncoming lane L2, the non-priority road Ls, and the no-traffic-light intersection CL detected by the traveling environment detector 11d or the traveling environment recognizer 13c. The vehicle information Db includes information on the speed of the first vehicle 100a, i.e., the vehicle speed, acquired from the vehicle position estimator 13b, and information on the vehicle (e.g., 100a and 100c to 100e) on the priority road Lm and the vehicle (e.g., 100b) on the non-priority road Ls acquired from the traveling environment detector 11d or the traveling environment recognizer 13c.

Thereafter, the traveling ECU 21 outputs the road information Da and the vehicle information Db to the ontology ECU 25. Upon acquiring the road information Da and the vehicle information Db from the traveling ECU 21, the ontology ECU 25 creates a scenario of a surrounding situation of the first vehicle 100a, based on the acquired road information Da and vehicle information Db (step S102). The ontology ECU 25 creates the scenario of the surrounding situation of the first vehicle 100a in a predetermined cycle (e.g., 0.5 seconds), for example, from when time taken until the first vehicle 100a reaches the no-traffic-light intersection CL, i.e., margin time, falls below a predetermined threshold.

The ontology ECU 25 determines a similarity level between the surrounding situation (scenario) of the first vehicle 100a and each risk situation (scenario) described in the ontology database 29 (step S103). At this time, the ontology ECU 25 determines the similarity level based on, for example, an instantiation ratio between the surrounding situation (scenario) of the first vehicle 100a and each risk situation (scenario) described in the ontology database 29.

The ontology ECU 25 determines that the similarity level is high, for example, when the instantiation ratio is greater than or equal to a predetermined threshold (step S104; Y). At this time, the ontology ECU 25 determines that the surrounding situation (scenario) of the first vehicle 100a is described in the ontology database 29. In contrast, the ontology ECU 25 determines that the similarity level is low, for example, when the instantiation ratio is less than the predetermined threshold (step S104; N). At this time, the ontology ECU 25 determines that the surrounding situation (scenario) of the first vehicle 100a is not described in the ontology database 29.

When it is determined that the similarity level is high, the ontology ECU 25 notifies the driver of occurrence of the risk event corresponding to the risk situation (scenario) determined as having the high similarity level (step S105). For example, the ontology ECU 25 generates warning sound data and outputs the warning sound data to a speaker of the first vehicle 100a, and the speaker of the first vehicle 100a outputs sound based on the inputted warning sound data.

When it is determined that the similarity level is high, the ontology ECU 25 further outputs, to the traveling ECU 21, a control signal indicating that the risk event corresponding to the risk situation (scenario) determined as having the high similarity level is likely to occur. Upon receiving such a control signal from the ontology ECU 25, the traveling ECU 21 performs traveling control to avoid the risk event corresponding to the risk situation (scenario) determined as having the high similarity level (step S106).

### Ontology Update Procedure

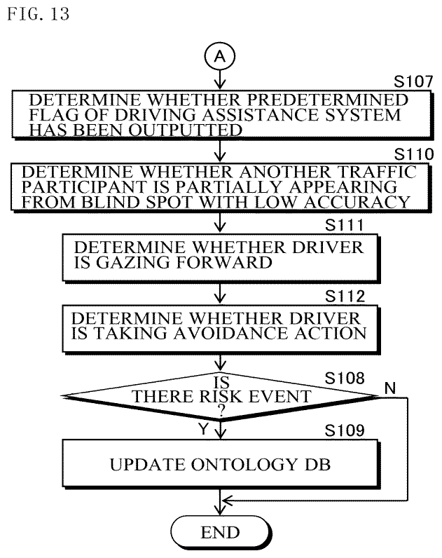

Next, a process of updating the ontology in the traveling control system 1 will be described referring to FIG. 12. FIG. 11 illustrates an example of the driving assistance procedure in the traveling control system 1.

When it is determined that the similarity level is low, the ontology ECU 25 determines whether a predetermined flag of the driving assistance system 31 has been outputted (step S107). The ontology ECU 25 determines, for example, whether the AEB primary braking activation flag, the AEB secondary braking activation flag, the AES activation flag, the ABS activation flag, the VDC warning flag, or the airbag activation flag has been outputted. The ontology ECU 25 uses the predetermined flag of the driving assistance system 31 to determine whether a risk event corresponding to the surrounding situation (scenario) of the first vehicle 100a is likely to occur (step S108). The ontology ECU 25 determines whether the risk event corresponding to the surrounding situation (scenario) of the first vehicle 100a is likely to occur depending on, for example, whether the AEB primary braking activation flag, the AEB secondary braking activation flag, the AES activation flag, the ABS activation flag, the VDC warning flag, or the airbag activation flag has been outputted. Note that a case where the predetermined flag of the driving assistance system 31 has not been outputted means that the driving assistance system 31 has not been activated.

The ontology ECU 25 infers the risk event corresponding to the surrounding situation (scenario) of the first vehicle 100a, based on the surrounding situation (scenario) of the first vehicle 100a and the traffic rules 28B and the traffic information 28C of the ontology database 29. When the predetermined flag of the driving assistance system 31 has been outputted, the ontology ECU 25 determines that the risk event corresponding to the surrounding situation (scenario) of the first vehicle 100a is likely to occur (step S108; Y). In contrast, when the predetermined flag of the driving assistance system 31 has not been outputted, the ontology ECU 25 determines that the risk event corresponding to the surrounding situation (scenario) of the first vehicle 100a is not likely to occur (step S108; N).

When it is determined that the risk event corresponding to the surrounding situation (scenario) of the first vehicle 100a is likely to occur, the ontology ECU 25 adds the surrounding situation (scenario) of the first vehicle 100a and the risk event obtained by inference in association with each other to the ontology database 29. In this way, the ontology ECU 25 updates the ontology database 29 by adding, to the ontology database 29, a new inference rule 28A that is a set of the surrounding situation (scenario) of the first vehicle 100a as the conditional term and the risk event obtained by inference as the resulting term (step S109). The ontology ECU 25 starts updating the ontology database 29 at a timing when it is determined that there is a risk event around the first vehicle 100a. In contrast, when it is determined that the risk event corresponding to the surrounding situation (scenario) of the first vehicle 100a is not likely to occur, the ontology ECU 25 does not update the ontology database 29.

### Effects

Next, effects of the traveling control system 1 according to an embodiment of the disclosure will be described.

In the embodiment, the similarity level between the surrounding situation (scenario) of the first vehicle 100a and each risk situation (scenario) described in the ontology database 29 is determined. As a result, when it is determined that the similarity level is low, it is determined that the surrounding situation (scenario) of the first vehicle 100a is not described in the ontology database 29. When it is determined that the similarity level is low, it is determined whether there is a risk event around the first vehicle 100a based on the predetermined flag of the driving assistance system 31. As a result, when it is determined that there is a risk event around the first vehicle 100a, the ontology database 29 is updated by adding the surrounding situation (scenario) of the first vehicle 100a and the risk event obtained by inference in association with each other to the ontology database 29.

Thus, in the embodiment, when the first vehicle 100a encounters a risk situation (scenario) that is not in the existing ontology database 29 and there is a risk event around the first vehicle 100a, the ontology database 29 is updated by adding the risk situation (scenario) at that time and the risk event in association with each other to the ontology database 29. Consequently, after the ontology database 29 is updated, it is possible for the first vehicle 100a to perform control based on prediction of the occurrence of the risk event read from the ontology database 29 upon encountering a similar risk situation.

In the embodiment, it is determined whether there is a risk event around the first vehicle 100a based on a signal (e.g., a predetermined activation flag) outputted from the driving assistance system 31. This makes it possible to avoid adding a situation (scenario) not involving a high risk to the ontology database 29. As a result, it is possible for the first vehicle 100a to perform control based on prediction of the occurrence of the risk event read from the ontology database 29 only in a situation actually involving a risk.

In the embodiment, updating of the ontology database 29 is started at the timing when it is determined that there is a risk event around the first vehicle 100a. This allows the ontology database 29 to be constantly kept up to date.

In the embodiment, the ontology database 29 is updated by adding, to the ontology database 29, a new inference rule 28A that is a set of the surrounding situation (scenario) of the first vehicle 100a as the conditional term and the risk event obtained by inference as the resulting term. After the ontology database 29 is updated, it is possible for the first vehicle 100a to perform control based on prediction of the occurrence of the risk event read from the ontology database 29 upon encountering a similar risk situation.

In the embodiment, the similarity level is determined based on the instantiation ratio between the surrounding situation (scenario) of the first vehicle 100a and each risk situation (scenario) described in the ontology database 29. Thus, for example, when the instantiation ratio is greater than or equal to the predetermined threshold, it is possible to determine that the similarity level is high, and determine that the surrounding situation (scenario) of the first vehicle 100a is described in the ontology database 29. In contrast, for example, when the instantiation ratio is less than the predetermined threshold, it is possible to determine that the similarity level is low, and determine that the surrounding situation (scenario) of the first vehicle 100a is not described in the ontology database 29. As a result, it is possible to easily determine whether the ontology database 29 is to be updated based on the instantiation ratio.

### 3. Modification Examples

Although the disclosure has been described with reference to the embodiments, the disclosure is not limited thereto, and may be modified in a variety of ways.

### Modification Example 3-1

In the above-described embodiment, the ontology ECU 25 determines whether the risk event corresponding to the surrounding situation (scenario) of the first vehicle 100a is likely to occur, based on whether the predetermined flag of the driving assistance system 31 has been outputted. However, in the above-described embodiment, the ontology ECU 25 may determine whether the risk event corresponding to the surrounding situation (scenario) of the first vehicle 100a is likely to occur, by considering other elements as well as the predetermined flag of the driving assistance system 31.

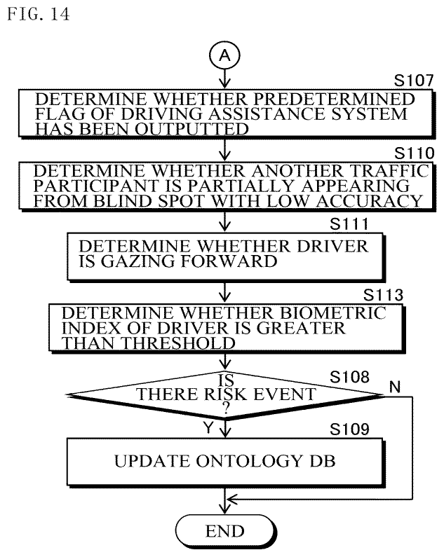

FIG. 13 illustrates a modification example of the procedure of updating the ontology database 29. After performing step S107, the ontology ECU 25 detects, for example, one or more risk factors included in the information (stereo images) obtained from the traveling environment detector 11d. After performing step S107, the ontology ECU 25 may detect, for example, one or more risk factors included in the data acquired by external communication (road-to-vehicle communication and vehicle-to-vehicle communication) through the transceiver 18.

The ontology ECU 25 determines, for example, whether another traffic participant (e.g., the second vehicle 100b) is partially appearing from a blind spot with low accuracy, i.e., whether there is a risk factor, based on the information obtained from the traveling environment detector 11d (step S110). The information obtained from the traveling environment detector 11d includes information on a three-dimensional object such as a structure present around the first vehicle 100a. The ontology ECU 25 may, for example, determine whether another traffic participant (e.g., the second vehicle 100b) is partially appearing from a blind spot with low accuracy, i.e., whether there is a risk factor, based on the data acquired by external communication (road-to-vehicle communication and vehicle-to-vehicle communication) through the transceiver 18. Here, examples of the “blind spot” include a vehicle parked or stopped on the road. Note that, when another traffic participant (e.g., the second vehicle 100b) is partially appearing from a blind spot with high accuracy, it is possible for the ontology ECU 25 to determine the similarity level by using information on the other traffic participant in step S103 described above.

The ontology ECU 25 further determines a driving behavior of the driver of the first vehicle 100a, based on data obtained from a device such as an imaging device (sensor) installed in the first vehicle 100a. The ontology ECU 25 determines, for example, whether the driver of the first vehicle 100a is gazing forward, based on the data obtained from the device such as an imaging device (sensor) installed in the first vehicle 100a. The ontology ECU 25 determines, for example, whether the driver of the first vehicle 100a is gazing at the other traffic participant described above, based on the data obtained from the device such as an imaging device installed in the first vehicle 100a (step S111).

The ontology ECU 25 further determines whether the driver of the first vehicle 100a is taking an avoidance action (step S112). The ontology ECU 25 may determine whether the driver of the first vehicle 100a is taking an avoidance action, for example, based on data obtained from various sensors installed in the first vehicle 100a, from the following three types of data combinations. In the following (2) and (3), it is suggested that the driver of the first vehicle 100a is taking an avoidance action because a positive or negative sign of a course of the first vehicle 100a indicates a direction opposite to that of the other traffic participant.
(1) Change rate of braking pressure+deceleration rate of first vehicle 100a
(2) Change rate of steering angle+positive or negative sign of course of first vehicle 100a
(3) Change rate of steering wheel torque+positive or negative sign of course of first vehicle 100a

Thus, the ontology ECU 25 determines whether the risk event corresponding to the surrounding situation (scenario) of the first vehicle 100a is likely to occur, by considering other elements (e.g., the presence of another traffic participant, the driving behavior of the driver of the first vehicle 100a, and an avoidance action of the driver of the first vehicle 100a) as well as the predetermined flag of the driving assistance system 31 (step S108). In this way, it is possible to estimate, with higher accuracy, the possibility of the risk event corresponding to the surrounding situation (scenario) of the first vehicle 100a occurring. This makes it possible to avoid adding a situation (scenario) not involving a high risk to the ontology database 29. As a result, it is possible for the first vehicle 100a to perform control based on prediction of the occurrence of the risk event read from the ontology database 29 only in a situation actually involving a risk.

Further, in the modification example, even in a situation in which the driving assistance system 31 is not activated, it is possible to estimate the possibility of the risk event corresponding to the surrounding situation (scenario) of the first vehicle 100a occurring by using other elements (e.g., the presence of another traffic participant, the driving behavior of the driver of the first vehicle 100a, and the avoidance action of the driver of the first vehicle 100a) as elements for determination.

Further, in the modification example, it is determined whether another traffic participant (e.g., the second vehicle 100b) is partially appearing from a blind spot with low accuracy, based on the information obtained from the traveling environment detector 11d and the data acquired by external communication (road-to-vehicle communication and vehicle-to-vehicle communication) through the transceiver 18. The information obtained from the traveling environment detector 11d includes information on a three-dimensional object such as a structure present around the first vehicle 100a. This makes it possible to perform sufficiently reliable estimation even with low accuracy.

### Modification Example 3-2

In the above-described modification example 3-1, instead of step S112, the ontology ECU 25 may, for example, determine whether data acquired from a sensor configured to detect the biometric index of the driver of the first vehicle 100a is greater than a predetermined threshold, as illustrated in FIG. 14 (step S113). It is possible for the ontology ECU 25 to estimate a psychological state of the driver of the first vehicle 100a by using the biometric index. This enables the ontology ECU 25 to determine whether the driver of the first vehicle 100a is taking an avoiding action even in a situation in which the driving assistance system 31 is not activated. As a result, it is possible for the ontology ECU 25 to determine whether there is a risk event around the first vehicle 100a.

### Modification Example 3-3

In the above-described embodiment and modification examples thereof, the disclosure is applied to driving assistance at the intersection CL where the priority road Lm and the non-priority road Ls intersect each other. However, in the above-described embodiment and modification examples thereof, for example, the disclosure may be applied to driving assistance at a merging point where the non-priority road Ls merges into the priority road Lm. Even in such a case, it is possible to achieve effects similar to those of the above-described embodiment and modification examples thereof.

### Modification Example 3-4

In the above-described embodiment and modification examples thereof, when it is difficult for the first vehicle 100a to communicate with the network environment NW, the traveling ECU 21 may acquire the road information Da and the vehicle information Db based on, for example, various pieces of data obtained from various sensors mounted on the first vehicle 100a. Here, the road information Da includes information on the priority road Lm, the traveling lane L1, the oncoming lane L2, the non-priority road Ls, and the no-traffic-light intersection CL detected by the traveling environment recognizer 13c. The vehicle information Db includes information on the speed of the first vehicle 100a, i.e., the vehicle speed, acquired from the vehicle position estimator 13b and information on the vehicle (e.g., 100a and 100c to 100e) on the priority road Lm and the vehicle (e.g., 100b) on the non-priority road Ls. Thus, even when it is determined whether there is a risk event around the first vehicle 100a based on the traffic situation in front of the first vehicle 100a obtained from the various sensors mounted on the first vehicle 100a, it is possible to achieve effects similar to those of the above-described embodiment and modification examples thereof.

The effects described herein are mere examples, and effects of the disclosure are not limited to those described herein. Accordingly, the disclosure may achieve any other effect.

The disclosure may also encompass the following configurations, for example.
(1)

An ontology update apparatus including
a controller configured to update an ontology, in which
the controller is configured to
determine a similarity level between a surrounding situation of a first vehicle and a risk situation described in the ontology, and determine that the surrounding situation is not described in the ontology when the controller determines that the similarity level is low, and
determine whether a risk event is present around the first vehicle, based on data that is obtained from a device mounted on the first vehicle at a time when the surrounding situation is acquired, and, when the controller determines that a risk event is present around the first vehicle, update the ontology by adding the surrounding situation and the risk event in association with each other to the ontology.
(2)

The ontology update apparatus according to (1), in which
the device includes a driving assistance system mounted on the first vehicle, and
the controller is configured to determine whether a risk event is present around the first vehicle, based on a signal outputted from the driving assistance system.
(3)

The ontology update apparatus according to (2), in which
the device is configured to determine whether a risk event is present around the first vehicle by using an activation flag of the driving assistance system.
(4)

The ontology update apparatus according to any one of (1) to (3), in which
the device includes a first sensor configured to detect a traffic situation in front of the first vehicle, and
the controller is configured to determine whether a risk event is present around the first vehicle, based on data obtained from the first sensor in a situation in which a driving assistance system mounted on the first vehicle is not activated.
(5)

The ontology update apparatus according to (4), in which
the first sensor includes a binocular camera configured to acquire stereo images of a region in front of the first vehicle, and
the controller is configured to detect one or more risk factors included in the stereo images obtained by the binocular camera, and determine whether a risk event is present around the first vehicle based on a result of detecting the one or more risk factors.
(6)

The ontology update apparatus according to (4), in which
the device includes the first sensor and a second sensor configured to detect a driving behavior, an avoidance action, or a biometric index of a driver of the first vehicle, and
the controller is configured to determine whether a risk event is present around the first vehicle, based on data obtained from both the first sensor and the second sensor in the situation in which the driving assistance system is not activated.
(7)

The ontology update apparatus according to (4), in which
the controller is configured to determine whether a risk event is present around the first vehicle, by acquiring an event from at least one of a third sensor or a communicator mounted on the first vehicle, the third sensor being configured to detect the event in front of the first vehicle, the communicator being configured to acquire the event in front of the first vehicle from an external device.
(8)

The ontology update apparatus according to any one of (1) to (7), in which
the controller is configured to start updating the ontology at a timing when the controller determines that a risk event is present around the first vehicle.
(9)

The ontology update apparatus according to any one of (1) to (8), in which
the controller is configured to update the ontology by adding a new inference rule that is a set of the surrounding situation as a conditional term and the risk event as a resulting term to the ontology.
(10)

The ontology update apparatus according to any one of (1) to (9), in which
the controller is configured to determine the similarity level, based on an instantiation ratio between the surrounding situation and the risk situation described in the ontology.
(11)

A vehicle including:
a storage containing an ontology; and
a controller configured to update the ontology, in which
the controller is configured to
determine a similarity level between a surrounding situation of a first vehicle and a risk situation described in the ontology, and determine that the surrounding situation is not described in the ontology when the controller determines that the similarity level is low, and
determine whether a risk event is present around the first vehicle, based on data that is obtained from a device mounted on the first vehicle at a time when the surrounding situation is acquired, and, when the controller determines that a risk event is present around the first vehicle, update the ontology by adding the surrounding situation and the risk event in association with each other to the ontology.
(12)

An ontology update method including:
determining a similarity level between a surrounding situation of a first vehicle and a risk situation described in the ontology, and determining that the surrounding situation is not described in the ontology when the controller determines that the similarity level is low; and
determining whether a risk event is present around the first vehicle, based on data that is obtained from a device mounted on the first vehicle at a time when the surrounding situation is acquired, and, when the controller determines that a risk event is present around the first vehicle, updating the ontology by adding the surrounding and the risk event in association with each other to the ontology.

The traveling control apparatus 10 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the traveling control apparatus 10 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the traveling control apparatus 10 illustrated in FIG. 1.

1. An ontology update apparatus, comprising:
a controller comprising circuitry configured to update an ontology,
wherein the circuitry of the controller is configured to determine a similarity level between a surrounding situation of a vehicle and a risk situation described in the ontology, and determine that the surrounding situation is not described in the ontology when the circuitry of the controller determines that the similarity level is low, and determine whether a risk event is present around the vehicle, based on data that is obtained from a device mounted on the vehicle at a time when the surrounding situation is acquired, and when the circuitry of the controller determines that a risk event is present around the vehicle, update the ontology by adding the surrounding situation and the risk event in association with each other to the ontology.

2. The ontology update apparatus according to claim 1, wherein the device comprises a driving assistance system mounted on the vehicle, and the circuitry of the controller is configured to determine whether a risk event is present around the vehicle based on a signal outputted from the driving assistance system.

3. The ontology update apparatus according to claim 2, wherein the circuitry of the controller is configured to determine whether a risk event is present around the vehicle by using an activation flag of the driving assistance system.

4. The ontology update apparatus according to claim 1, wherein the device includes a first sensor configured to detect a traffic situation in front of the vehicle, and the circuitry of the controller is configured to determine whether a risk event is present around the vehicle based on data obtained from the first sensor in a situation in which a driving assistance system mounted on the vehicle is not activated.

5. The ontology update apparatus according to claim 4, wherein the first sensor comprises a binocular camera configured to acquire stereo images of a region in front of the vehicle, and the circuitry of the controller is configured to detect one or more risk factors included in the stereo images obtained by the binocular camera, and determine whether a risk event is present around the vehicle based on a result of detecting the one or more risk factors.

6. The ontology update apparatus according to claim 4, wherein the device includes the first sensor and a second sensor configured to detect a driving behavior, an avoidance action, or a biometric index of a driver of the vehicle, and the circuitry of the controller is configured to determine whether a risk event is present around the vehicle based on data obtained from both the first sensor and the second sensor in the situation in which the driving assistance system is not activated.

7. The ontology update apparatus according to claim 4, wherein the circuitry of the controller is configured to determine whether a risk event is present around the vehicle by acquiring an event from at least one of a third sensor or a communicator mounted on the vehicle, the third sensor is configured to detect the event in front of the vehicle, and the communicator is configured to acquire the event in front of the vehicle from an external device.

8. The ontology update apparatus according to claim 1, wherein the circuitry of the controller is configured to start updating the ontology at a timing when the circuitry of the controller determines that a risk event is present around the vehicle.

9. The ontology update apparatus according to claim 1, wherein the circuitry of the controller is configured to update the ontology by adding a new inference rule that is a set of the surrounding situation as a conditional term and the risk event as a resulting term to the ontology.

10. The ontology update apparatus according to claim 1, wherein the circuitry of the controller is configured to determine the similarity level based on an instantiation ratio between the surrounding situation and the risk situation described in the ontology.

11. A vehicle, comprising:
a storage containing an ontology; and
a controller comprising circuitry configured to update the ontology,
wherein the circuitry of the controller is configured to determine a similarity level between a surrounding situation of the vehicle and a risk situation described in the ontology, and determine that the surrounding situation is not described in the ontology when the controller determines that the similarity level is low, and determine whether a risk event is present around the vehicle, based on data that is obtained from a device mounted on the vehicle at a time when the surrounding situation is acquired, and when the circuitry of the controller determines that a risk event is present around the vehicle, update the ontology by adding the surrounding situation and the risk event in association with each other to the ontology.

12. An ontology update method, comprising:
determining a similarity level between a surrounding situation of a vehicle and a risk situation described in an ontology;
determining that the surrounding situation is not described in the ontology when a controller comprising circuitry determines that the similarity level is low; and
determining whether a risk event is present around the vehicle, based on data that is obtained from a device mounted on the vehicle at a time when the surrounding situation is acquired, and, when the circuitry of the controller determines that a risk event is present around the vehicle, updating the ontology by adding the surrounding situation and the risk event in association with each other to the ontology.
